(19) United States
(12) Patent Application Publication
(10) Pub. No.: US 2005/0164070 A1
(43) Pub. Date: Jul. 28, 2005

(54) Extruded bipolar plates

(76) Inventors: Paul E. Krajewski, Sterling Heights, MI (US); Raja K. Mishra, Shelby Township, MI (US)

Correspondence Address: CARY W. BROOKS;General Motors Corporation, Legal Staff, Mail Code 482-C23-B21, P.O. Box 300, Detroit, MI, 48265-3000, US

(21) Appl. No.: 10/765,822

(22) Filed: Jan. 27, 2004

(51) Int. Cl. H01M 8/02; H01M 8/10; H01M 8/04; B21C 23/00

(52) U.S. Cl. 429/38; 429/30; 429/26; 72/254

(57) ABSTRACT

An extruded bipolar plate for a fuel cell. The bipolar plate is fabricated by an extrusion process so that the extruder die forms linear channels in the extrusion for the flow channels in the plate. A variety of different shapes can be provided for the flow channels. In one design, the flow channels for the cooling fluid extend through the center of the bipolar plates, and flow channels for the anode and cathode fluids are provided on the outside of the bipolar plate. Further, the sides of the bipolar plate can be formed with a recess to receive end caps to secure the plates together. In addition, the end cap can include flow channels to control the flow of the fluids to the plates when the fuel cell stack is assembled.

### BACKGROUND OF THE INVENTION

1. Field of the Invention

This invention relates generally to bipolar plates for a fuel cell and, more particularly, to bipolar plates for a fuel cell that are extruded to provide the various flow channels within the plates.

2. Discussion of the Related Art

Hydrogen is a very attractive fuel because it is clean and can be used to efficiently produce electricity in a fuel cell. The automotive industry expends significant resources in the development of hydrogen fuel cells as a source of power for vehicles. Such vehicles would be more efficient and generate fewer emissions than today's vehicles employing internal combustion engines.

A hydrogen fuel cell is an electrochemical device that includes an anode and a cathode with an electrolyte therebetween. The anode receives hydrogen gas and the cathode receives oxygen or air. The hydrogen gas is disassociated in the anode to generate free hydrogen protons and electrons. The hydrogen protons pass through the electrolyte to the cathode. The hydrogen protons react with the oxygen and the electrons in the cathode to generate water. The electrons from the anode cannot pass through the electrolyte, and thus are directed through a load to perform work before being sent to the cathode. The work acts to operate the vehicle.

Proton exchange membrane fuel cells (PEMFC) are a popular fuel cell for vehicles. The PEMFC generally includes a solid polymer electrolyte proton conducting membrane, such as a perfluorosulfonic acid membrane. The anode and cathode typically include finely divided catalytic particles, usually platinum (Pt), supported on carbon particles and mixed with an ionomer. The combination of the anode, cathode and membrane define a membrane electrode assembly (MEA). MEAs are relatively expensive to manufacture and require certain conditions for effective operation. These conditions include proper water management and humidification, and control of catalyst poisoning constituents, such as carbon monoxide (CO).

Many fuel cells are typically combined in a fuel cell stack to generate the desired power. For example, a typical fuel cell stack for an automobile may have two hundred stacked fuel cells. The fuel cell stack receives a cathode input gas as a flow of air, typically forced through the stack by a compressor. Not all of the oxygen in the air is consumed by the stack and some of the air is output as a cathode exhaust gas that may include water as a stack by-product. The fuel cell stack also receives an anode hydrogen input gas that flows into the anode side of the stack.

The fuel cell stack includes a series of bipolar plates positioned between the several membranes in the stack. For the automotive fuel cell stack mentioned above, the stack would include about four hundred bipolar plates, and are typically made of stainless steel. The bipolar plates include an anode side and a cathode side for adjacent fuel cells in the stack. The bipolar plates are made of a conductive material so that they conduct the electricity generated by the fuel cells out of the stack. The bipolar plates also include flow channels through which a cooling fluid and the anode and cathode fluids for the electrochemical reaction flow, as is well understood in the art.

Currently, each bipolar plate is made by joining two separate plates after the flow channels in the plates have been formed. In one technique, each separate plate is formed by a stamping or etching process to form the channels in the plate. The two plates are then secured together by welding or brazing along the edges and predetermined weld lines to join the plates to form the bipolar plate and seal the channels. However, such a stamping, welding and/or brazing process is very labor intensive, and must provide a high seal integrity. If the seal integrity anywhere along the weld or braze line is compromised, and the flow channel leaks, the entire fuel cell stack cannot be used.

### SUMMARY OF THE INVENTION

In accordance with the teachings of the present invention, an extruded bipolar plate for a fuel cell is disclosed. The bipolar plate is formed by an extrusion process where the extruder die forms linear channels in the extrusion to define the various flow channels in the plate. Because the bipolar plate is formed by the extrusion process, two separate plates do not need to be joined to form the bipolar plate. A variety of different shapes can be provided by the extrusion process to form the flow channels. In one design, the flow channels for the cooling fluid extend through the center of the bipolar plates, and flow channels for the anode and cathode fluids are provided on the outside of the bipolar plate. Further, the extrusion process can form recesses in the sides of the bipolar plates to receive end caps to secure the plates together. In addition, the end caps can include channels to control the flow of the fluids to the plates when the fuel cell stack is assembled.

Additional advantages and features of the present invention will become apparent from the following description and appended claims, taken in conjunction with the accompanying drawings.

### BRIEF DESCRIPTION OF THE DRAWINGS

FIG. 1 is a plan view of an extrusion system for extruding bipolar plates for a fuel cell, according to an embodiment of the present invention;

FIGS. 2-6 are cross-sectional, perspective views of an extruded bipolar plate, according to the invention;

FIG. 7 is a cross-sectional, perspective view of an extruded bipolar plate including recessed edges for accepting side caps, according to another embodiment of the present invention;

FIGS. 8 and 9 are cross-sectional, perspective views of an extruded bipolar plate including center cooling flow channels and outside cathode and anode flow channels, according to another embodiment of the present invention;

FIG. 10 is an exploded, broken-away, cross-sectional, perspective view of a fuel cell including extruded bipolar plates, according to another embodiment of the present invention; and

FIG. 11 is a cross-sectional view of a fuel cell including extruded bipolar plates and side caps, according to another embodiment of the present invention.

### DETAILED DESCRIPTION OF THE EMBODIMENTS

The following description of the embodiments of the invention directed to an extruded bipolar plate for a fuel cell is merely exemplary in nature, and is in no way intended to limit the invention or its applications or uses.

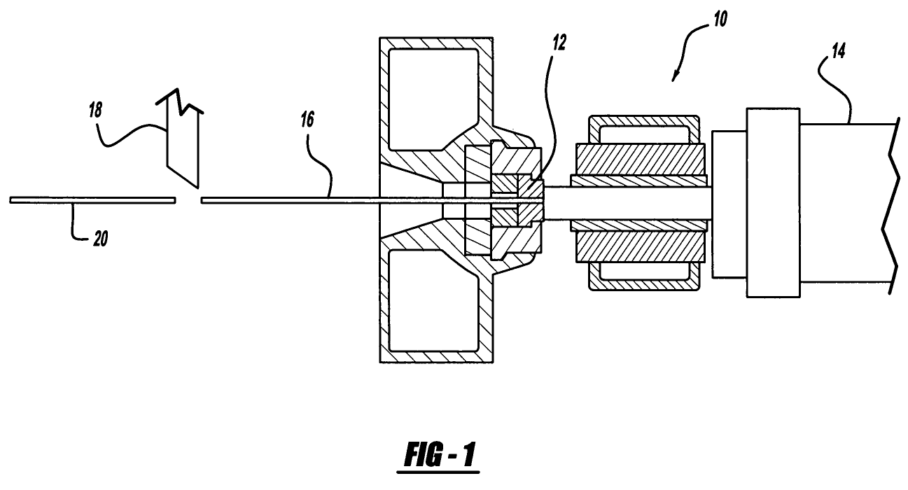

The present invention is directed to extruded bipolar plates for a fuel cell stack. FIG. 1 is a representative plan view of an extrusion device 10 including a die 12 for forming the bipolar plates. A suitable metal is heated in the device 10, and is forced through the die 12 by a ram 14 to form an extruded stream 16 by an extrusion process that is well understood to those skilled in the art. The extruded stream 16 includes linear or unidirectional flow channels formed by the die 12 for a particular bipolar plate design, as will be discussed in greater detail below. A knife 18 cuts the stream 16 into sections 20 that are later machined and formed for each separate bipolar plate for a fuel cell stack consistent with the discussion herein. Because the bipolar plates are formed by an extrusion process, two separate plates do not need to be joined to form each bipolar plate as was done in the prior art. Therefore, less labor is required to make the plates.

The extrusion device 10 can be any extrusion device suitable for the purposes described herein, and many are known in the art that would be applicable. The metal can be any conductive metal suitable for a bipolar plate and applicable to be extruded. In one embodiment, the metal is aluminum, however, other metals, such as magnesium, stainless steel, titanium, etc., may be applicable.

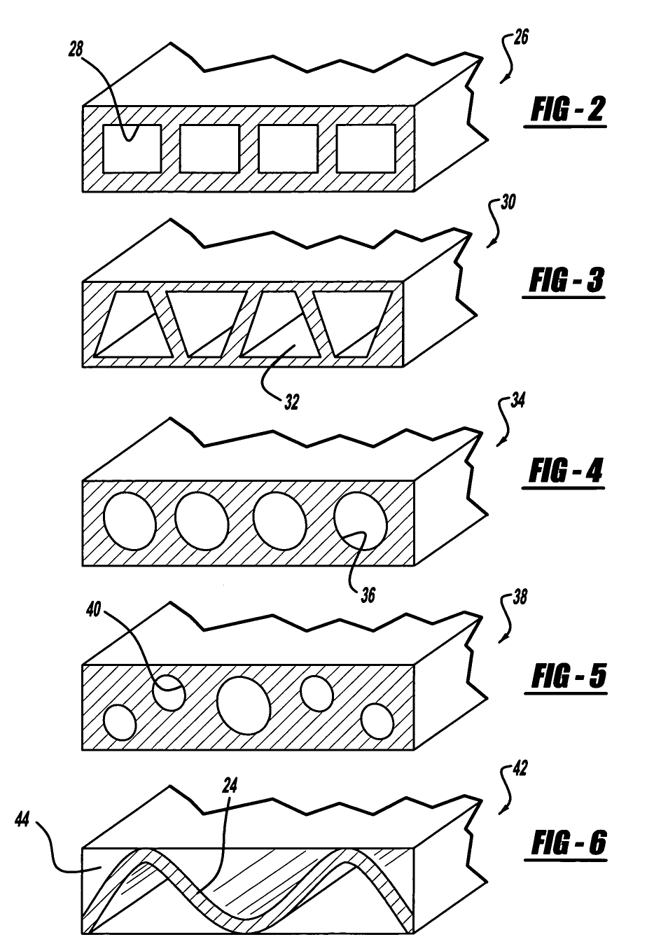

The die 12 and the extrusion device 10 can form any desired design of flow channels within the bipolar plate for a particular fuel cell stack. The only requirement for the extrusion process is that the flow channels formed therein are linear because of the limitations of the extrusion process. FIGS. 2-6 show representative examples of different designs for the flow channels in the bipolar plates of the invention. Particularly, FIG. 2 is a broken-away, perspective view of an extruded bipolar plate 26 including square flow channels 28 aligned in series. FIG. 3 is a broken-away, perspective view of an extruded bipolar plate 30 including alternating trapezoidal-shaped flow channels 32. FIG. 4 is a broken-away, perspective view of an extruded bipolar plate 34 including cylindrical flow channels 36 where all of the flow channels 36 are of the same diameter. FIG. 5 is a broken-away, perspective view of an extruded bipolar plate 38 including cylindrical flow channels 40 where the flow channels 40 have varying diameters. FIG. 6 is a broken-away, perspective view of an extruded bipolar plate 42 including flow channels 44 formed by a sinusoidal structure 24. In these embodiments, the flow channels 28, 32, 36, 40 and 44 are for a cooling fluid.

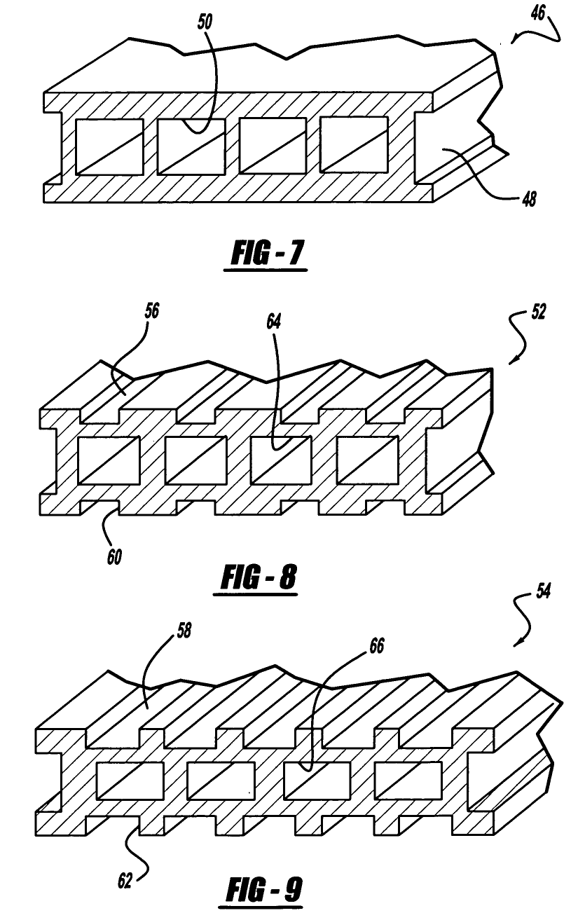

In addition to the cooling flow channels in the extruded bipolar plate, the extrusion process can also form recessed edges in the plate that provide a structure for securing the adjacent plates in the stack together. FIG. 7 is a broken-away, perspective view of an extruded bipolar plate 46 including recesses 48 for this purpose. The recesses 48 also act to reduce the amount of metal in the plate 46 to reduce the weight of the fuel cell stack. In this design, the flow channels 50 are square.

FIGS. 8 and 9 show extruded bipolar plates 52 and 54, respectively, that are similar to the bipolar plate 46. However, in this design anode flow channels 56 and 58 and cathode flow channels 60 and 62 are extruded into the bipolar plates 52 and 54, respectively, as shown. The anode flow channels 56 and 58 are formed at the anode side of the plates 52 and 54 so that they face the anode side of the membrane in the stack. Likewise, the cathode flow channels 60 and 62 are formed at the cathode side of the plates 52 and 54 so that they face the cathode side of the membrane in the stack. The bipolar plate 52 includes square cooling flow channels 64 and the bipolar plate 54 includes rectangular cooling flow channels 66. The bipolar plate 52 has a design that could optimize cooling through the center of the plate 52, and the bipolar plate 54 has a design that could optimize the anode and cathode flow channels 58 and 62.

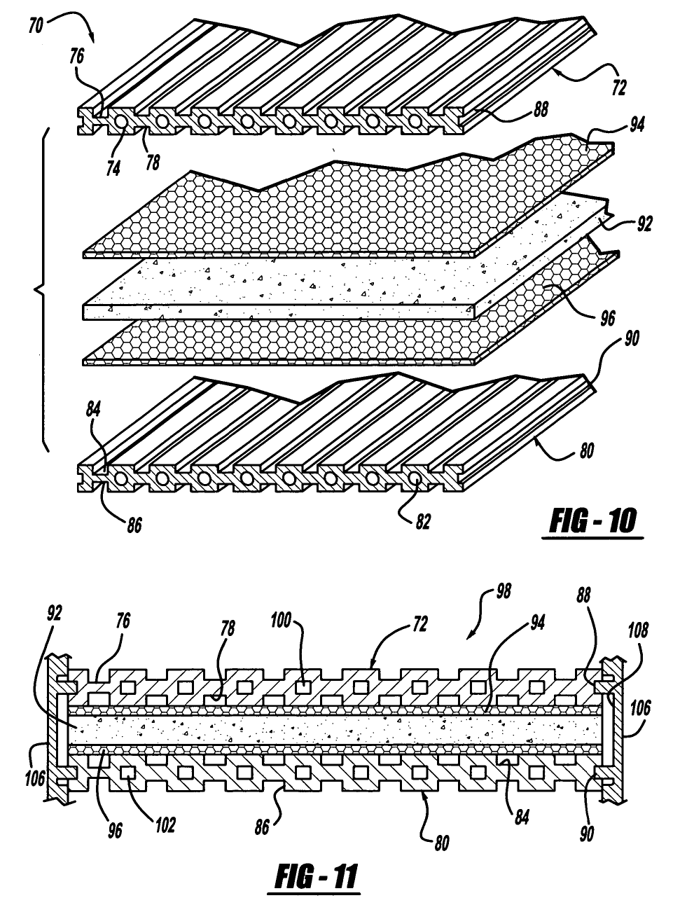

FIG. 10 is an exploded, broken-away, cross-sectional, perspective view of a fuel cell 70 showing a fuel cell design employing extruded bipolar plates of the invention. Particularly, the fuel cell 70 includes a top bipolar plate 72 including cylindrical cooling flow channels 74, anode flow channels 76, cathode flow channels 78 and recessed edges 88. Likewise, the fuel cell 70 includes a bottom bipolar plate 80 including cylindrical cooling flow channels 82, anode flow channels 84, cathode flow channels 86 and recessed edges 90. A diffusion media layer 94 is positioned adjacent to the bipolar plate 72, and a diffusion media layer 96 is positioned adjacent to the bipolar plate 80 as is well known in the art. A cell membrane 92 is positioned between the diffusion media layers 94 and 96. The anode flow channels are part of the anode side of a fuel cell stacked on top of the fuel cell 70, and the cathode flow channels 86 are part of the cathode side of a fuel cell stacked below the fuel cell 70.

FIG. 11 is a cross-sectional view of a fuel cell 98 similar to the fuel cell 70, where like reference numerals identify like elements. In this design, the top bipolar plate 72 includes square cooling channels 100 and the bottom bipolar plate 80 includes square cooling channels 102. Additionally, the recessed edges 88 and the recessed edges 90 accept end caps 106. In one embodiment, the end caps 106 are made of a metal or polymeric material, and have flid channels 108 to control the flow of the fluids to the plates 72 and 80.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

1. A fuel cell comprising:
a first bipolar plate including flow channels;
a second bipolar plate including flow channels; and
a membrane formed between the first and second bipolar plates, wherein the first and second bipolar plates are extruded bipolar plates where the flow channels are formed by an extrusion process.

2. The fuel cell according to claim 1 wherein the flow channels in the first and second bipolar plates are selected from the group consisting of square, rectangular, trapezoidal, round, sinusoidal and elliptical shaped flow channels.

3. The fuel cell according to claim 1 wherein the flow channels include flow channels for a cooling fluid.

4. The fuel cell according to claim 3 wherein the flow channels extend through a middle portion of the first and second bipolar plates.

5. The fuel cell according to claim 1 wherein the flow channels include anode flow channels and cathode flow channels.

6. The fuel cell according to claim 5 wherein the anode and cathode flow channels are provided at outside edges of the first and second bipolar plates.

7. The fuel cell according to claim 1 wherein the first and second bipolar plates include recessed edges.

8. The fuel cell according to claim 7 further comprising end plates positioned in the recessed edges for securing the first and second bipolar plates together.

9. The fuel cell according to claim 1 wherein the first and second bipolar plates are extruded aluminum plates.

10. The fuel cell according to claim 1 wherein the fuel cell is for an automotive application.

11. A bipolar plate for a fuel cell, said bipolar plate comprising a series of flow channels extending through the plate, said bipolar plate being an extruded bipolar plate where the flow channels are formed by an extrusion process.

12. The bipolar plate according to claim 11 wherein the flow channels are selected from the group consisting of square, rectangular, trapezoidal, round, sinusoidal and elliptical shaped flow channels.

13. The bipolar plate according to claim 11 wherein the flow channels include flow channels for a cooling fluid.

14. The bipolar plate according to claim 11 wherein the flow channels include anode flow channels and cathode flow channels.

15. The bipolar plate according to claim 11 wherein the flow channels extend through a middle portion of the plate.

16. The bipolar plate according to claim 11 wherein the flow channels are provided at outside edges of the plate.

17. The bipolar plate according to claim 11 further comprising recessed edges.

18. The bipolar plate according to claim 11 wherein the plate is an extruded aluminum plate.

19. A method for fabricating a bipolar plate for a fuel cell, said method comprising:
providing an extrusion device;
extruding a stream of a metal through the extrusion device so that the stream includes flow channels extending therethrough; and
cutting the stream to form the bipolar plate having flow channels.

20. The method according to claim 19 wherein extruding the stream includes forming the flow channels through one or both of a middle portion of the stream and edges of the stream.

21. The method according to claim 19 wherein extruding the stream includes forming recesses in side edges of the stream.
